(19) United States
(12) Patent Application Publication
(10) Pub. No.: US 2021/0117785 A1
(43) Pub. Date: Apr. 22, 2021

(54) SYSTEM AND METHOD FOR AUTOMATICALLY RECOGNIZING VIRTUAL BALL SPORTS INFORMATION

(71) Applicant: Electronics and Telecommunications Research Institute, Daejeon (KR)

(72) Inventors: Jong Sung KIM, Daejeon (KR); Myung Gyu KIM, Daejeon (KR); Woo Suk KIM, Daejeon (KR); Seong Min BAEK, Daejeon (KR); Sang Woo SEO, Daejeon (KR); Sung Jin HONG, Incheon (KR)

(73) Assignee: Electronics and Telecommunications Research Institute, Daejeon (KR)

(21) Appl. No.: 17/033,037

(22) Filed: Sep. 25, 2020

(30) Foreign Application Priority Data
Oct. 21, 2019 (KR) 10-2019-0130887

(51) Int. Cl. G06N 3/08; A63B 71/00; G06N 3/04

(52) U.S. Cl. CPC G06N 3/08; A63B 2220/05; G06N 3/04; A63B 71/00

(57) ABSTRACT

Provided is a system and method for automatically recognizing virtual ball sports information, specifically, a system and method for automatically recognizing virtual ball sports events and motions on the basis of ball measurement data training. Provided is a server for automatically recognizing virtual ball sports information including an inputter configured to receive ball measurement data, a memory which stores a program for automatically recognizing virtual ball sports information, and a processor configured to execute the program, wherein the processor automatically recognizes an event and a motion of a sport that is currently played by a user using the ball measurement data and a ball classification label.

### CROSS-REFERENCE TO RELATED APPLICATION

This application claims priority to and the benefit of Korean Patent Applications No. 10-2019-0130887, filed on Oct. 21, 2019, the disclosure of which is incorporated herein by reference in its entirety.

### BACKGROUND

### 1. Field of the Invention

The present invention relates to a system and method for automatically recognizing virtual ball sports information, and more specifically, to a system and method for automatically recognizing a virtual ball sports event and a motion on the basis of ball measurement data training.

### 2. Discussion of Related Art

The conventional unified virtual ball sports system automatically recognizes an event and a motion of a ball sport currently played by a user according to a method of learning image data photographed by the user.

However, the conventional technology requires a separate camera device for photographing a user, a large amount of user image data previously labeled for learning, and a very complicated and time-consuming learning process, such as a convolutional neural network (CNN).

### SUMMARY OF THE INVENTION

The present invention provides a system and method for automatically recognizing virtual ball sports information that are capable of efficiently recognizing an event and a motion of a sport that is played by a user in an automatic manner by training a small amount of measurement data (ball measurement data) generated while a user is using a unified virtual ball sports system without having a separate device for recognizing a user image, constructing a large amount of data, and performing a time consuming learning process.

The technical objectives of the present invention are not limited to the above, and other objectives may become apparent to those of ordinary skill in the art based on the following description.

According to one aspect of the present invention, there is provided a server for automatically recognizing virtual ball sports information, the server including an inputter configured to receive ball measurement data, a memory which stores a program for automatically recognizing virtual ball sports information, and a processor configured to execute the program, wherein the processor automatically recognizes information about a virtual ball sports that is currently played by a user using the ball measurement data and a ball classification label.

According to another aspect of the present invention, there is provided a system for automatically recognizing virtual ball sports information, the system including a data measurer configured to measure and collect ball measurement data, a ball measurement data trainer configured to perform learning using deep neural network (DNN) model learning which uses the ball measurement data and a label regarding a virtual ball sport, and a ball measurement data classifier configured to calculate virtual ball sports information corresponding to the ball measurement data according to a result of the DNN model learning.

According to another aspect of the present invention, there is provided a method of automatically recognizing virtual ball sports information, the method including the steps of (a)

receiving ball measurement data acquired from a measuring device mounted within a unified virtual ball sports system, (b) defining a label associated with an event and a user motion as virtual ball sports information, (c) performing ball measurement data-based learning using the ball measurement data and the label, (d) estimating a ball classification label corresponding to the ball measurement data, and (e) automatically recognizing an event and a user motion of a sport that is currently played by a user in the unified virtual ball sports system.

### BRIEF DESCRIPTION OF THE DRAWINGS

FIG. 1 illustrates a process of automatically recognizing virtual ball sports information according to an embodiment of the present invention.

FIG. 2 illustrates an automatic recognition server for virtual ball sports information according to an embodiment of the present invention.

FIG. 3 illustrates a deep neural network (DNN) model for automatic recognition of virtual ball sports information according to an embodiment of the present invention.

FIG. 4 is a block diagram illustrating a system for automatically recognizing virtual ball sports information according to an embodiment of the present invention.

FIG. 5 is a flowchart showing a method of automatically recognizing virtual ball sports information according to an embodiment of the present invention.

### DETAILED DESCRIPTION OF EXEMPLARY EMBODIMENTS

Hereinafter, the above and other objectives, advantages, and features of the present invention and manners of achieving them will become readily apparent with reference to descriptions of the following detailed embodiments when considered in conjunction with the accompanying drawings

However, the present invention is not limited to such embodiments and may be embodied in various forms. The embodiments to be described below are provided only to assist those skilled in the art in fully understanding the objectives, constitutions, and the effects of the invention, and the scope of the present invention is defined only by the appended claims.

Meanwhile, terms used herein are used to aid in the explanation and understanding of the embodiments and are not intended to limit the scope and spirit of the present invention. It should be understood that the singular forms “a,” “an,” and “the” also include the plural forms unless the context clearly dictates otherwise. The terms “comprises,” “comprising,” “includes,” and/or “including,” when used herein, specify the presence of stated features, integers, steps, operations, elements, components and/or groups thereof and do not preclude the presence or addition of one or more other features, integers, steps, operations, elements, components, and/or groups thereof.

Before describing embodiments of the present invention, a background for proposing the present invention will be described first for the sake of understanding of those skilled in the art.

There is provided a service that allows sports to be virtually experienced by simulating a flight trajectory and a collision trajectory of a ball on the basis of ball size, position, velocity, and rotation data measured when a user uses (kicking, striking, hitting, or throwing a ball) a virtual sports simulator, such as virtual soccer, virtual baseball, virtual golf, virtual tennis, or virtual bowling.

There is proposed a unified virtual ball sports system that allows a user to freely experience various virtual ball sports simulation events through a single system in one place without moving to other locations, and in order to provide such a service, the system needs to receive information in advance about a sports event currently selected by the user or automatically recognize a motion of the user.

According to the related art, in order to automatically recognize an event and a motion of a ball sport selected by the user instead of receiving information about ball sports events and motions in advance by a unified vertical ball sports system, a method of automatically recognizing an event and a motion of a ball sport currently played by a user (a user image data learning method) by photographing a user who virtually experiences a ball sport through a separately installed photography device, labeling sports events and motions corresponding to the acquired image of the user, and training the large amount of labeled user image data through the latest deep learning technique, such as a convolutional neural network (CNN), has been proposed.

However, the user image data learning method according to the related art requires a camera device for photographing a user separately from the unified virtual ball sports system, a large amount of previously labeled user image data for automatically recognizing ball sports events and motions, and a very complicated and time-consuming learning process, such as a CNN.

The present invention is proposed to obviate the above-described limitations and provides a system and method in which a small amount of measurement data, such as measurement data of a ball generated while the user is using a unified virtual ball sports system (size, position, velocity, and spin data of the ball) is trained through a short-time learning technique, such as a deep neural network (DNN) among deep learning techniques, and through a DNN model trained thereby, an event and a motion of a virtual ball sport currently played by the user are automatically recognized.

The present invention is applied to a unified virtual ball sports system that has virtual ball sports simulators, such as virtual soccer, virtual baseball, virtual golf, virtual tennis, virtual bowling, and the like, available for a user to freely experience a desired event and a motion through the unified virtual ball sports system in one place so that measurement data of a ball generated while the user is using the system, that is, a low amount of measurement data, such as size, position, velocity, and spin data of the ball, is trained through a short time learning technique, such as a DNN among deep learning techniques, and through a DNN model trained thereby, an event and a motion of a virtual ball sport currently played by the user are automatically recognized.

According to the related art (the user image data learning method), there is a need to train a large amount of image data, such as image data of a user acquired through a separately installed camera device for recognizing an event and a motion of a sport currently played by a user who uses a unified virtual ball sports system through a very complicated process using a long time learning technique, such as a CNN developed for learning a large amount of image data, among deep learning techniques.

On the other hand, according to the present invention, a small amount of measurement data, such as ball size, position, velocity, and rotation data measured by a measuring device mounted within a unified virtual ball sports system for ball sports simulation is trained during use of the unified virtual ball sports system through the DNN so that the user may efficiently and automatically recognize an event and a motion of the virtual ball sports currently played by the user.

The present invention provides a system and method for automatically recognizing virtual ball sports information (an event and a motion) on the basis of ball measurement data training, in which a unified virtual ball sports system is capable of automatically recognizing an event and a motion of a sport currently played by a user through use of an internal device for ball measurement data acquisition, construction of a small amount of data, and execution of short time learning.

Hereinafter, operation principles of the present invention will be described in detail with reference to the accompanying drawings. In the descriptions, details of related known functions or constructions will be omitted to avoid obscuring the subject matter of the present invention. Although terms used herein are selected from among general terms that are currently and widely used in consideration of functions in the exemplary embodiments, these may be changed according to intentions or customs of those skilled in the art or the advent of new technology. Therefore, the meanings of the terms used herein should be interpreted based on content of this entire specification.

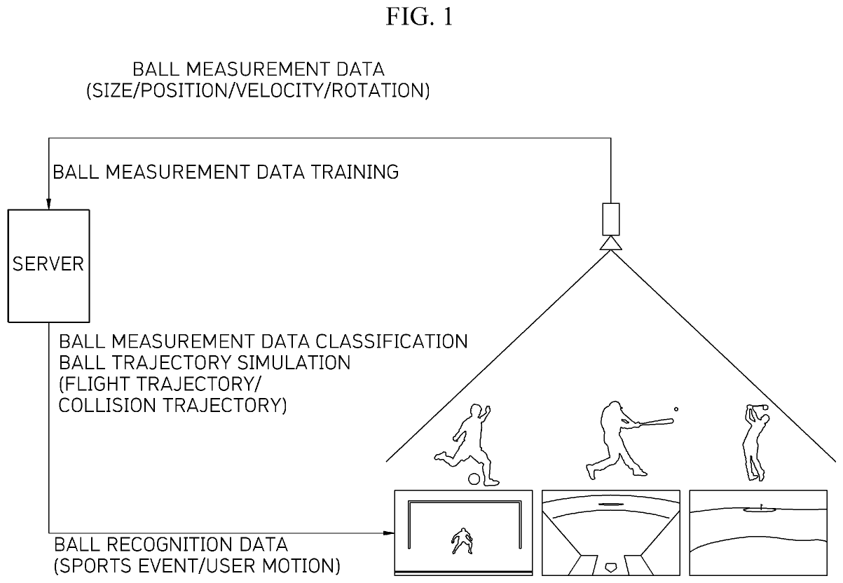

FIG. 1 illustrates a process of automatically recognizing virtual ball sports information according to an embodiment of the present invention.

According to the embodiment of the present invention, ball measurement data is obtained from a measuring device 200 mounted within a system for ball sports simulation.

The ball measurement data includes information regarding the size, position, velocity, and rotation of a ball.

An automatic recognition server 100 for virtual ball sports information receives the ball measurement data to perform learning, classifies the ball measurement data, simulates a flight trajectory or a collision trajectory of the ball, and transmits a control command for providing contents for a virtual sports experience.

In addition, the automatic recognition server 100 for virtual ball sports information recognizes information regarding an event and a user motion of a sport currently played by a user through ball recognition data.

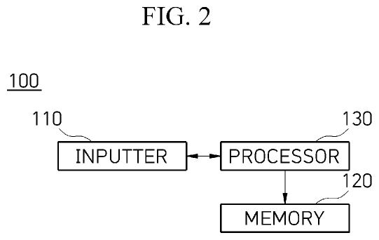

FIG. 2 illustrates the automatic recognition server 100 for virtual ball sports information according to the embodiment of the present invention.

The automatic recognition server 100 for virtual ball sports information according to the embodiment of the present invention includes an inputter 110 configured to receive ball measurement data, a memory 120 which stores a program for automatically recognizing virtual ball sports information, and a processor 130 configured to execute the program, and the processor 130 recognizes an event and a motion of a sport currently played by a user using the ball measurement data and a ball classification label.

The inputter 110 receives the ball measurement data including at least one of size, position, velocity and rotation data of a ball measured by the measuring device 200 mounted within a unified virtual ball sport system.

The processor 130 performs normalization on the ball measurement data in consideration of the maximum value of the ball measurement data and uses the normalized data for DNN model learning.

The processor 130 performs automatic recognition on the virtual ball sports information including the sports events and motions on the basis of the DNN model learning.

The processor 130 uses the ball classification label in which a sports event and a user motion corresponding to the collected ball measurement data have been input in advance for the DNN model learning.

The processor 130 calculates a weight and a bias of an interior of the DNN model such that a cost function is minimized through a process of learning the ball measurement data using the ball measurement data and the ball classification label corresponding thereto, to perform the DNN model learning.

The inputter 110 receives ball size data acquired through the measuring device 200 mounted in the unified virtual ball sports system while the user is playing a specific sports event using the unified virtual ball sports system.

The size of the ball is measured N times through the measuring device 200, and the ball size data R collected by the inputter 110 is defined as in Equation 1 below.

\hat{R}={\hat{R}₁, . . . ,\hat{R}ᵢ . . . ,\hat{R}_{N}} [Equation 1]

The unit of size of a ball is an internal unit of the system (e.g., pixel) or a unit of size in physics (e.g., mm).

The dimension of each ball size constituting the ball size data \hat{R} is one dimension, and an i^{th} ball size \hat{R}ᵢ is a measurement value normalized as shown in Equation 2 below.

The processor 130 normalizes the ball size data to recognize the virtual ball sports information using the ball size data.

\hat{R}ᵢ=Rᵢ/R^{max} [Equation 2]

Rᵢ is an actual ball size measurement value measured in the system, and R^{max} is the maximum ball size measurement value that is measurable through the system.

The inputter 110 receives ball position data measured by the measuring device 200. The ball position is measured N times, and the collected ball position data \hat{P} is defined as in Equation 3 below.

\hat{P}={\hat{P}₁, . . . ,\hat{P}ᵢ, . . . ,\hat{P}_{N}} [Equation 3]

The unit of position of a ball is an internal unit of the system (e.g., pixel) or a unit of position in physics (e.g., mm).

The dimension of each ball position vector constituting the ball position data \hat{P} is two dimensions or three dimensions.

When the ball position vector is two-dimensional, an i^{th} two-dimensional ball position vector \hat{P}ᵢ is defined as Equation 4 below, and when the ball position vector is three-dimensional, an i^{th} three-dimensional ball position vector \hat{P}ᵢ is defined as a normalized measurement value as shown in Equation 5 below.

The processor 130 normalizes the ball position data to recognize the virtual ball sports information.

\hat{P}ᵢ=(P_{x,i}/Pₓ^{max},P_{y,i}/P_{y}^{max}) [Equation 4]

\hat{P}ᵢ=(P_{x,i}/Pₓ^{max},P_{y,i}/P_{y}^{max},P_{z,i},P_{z}^{max}) [Equation 5]

P_{x,i}, P_{y,i}, P_{z,i} are actual ball position measurement values measured in the system, and Pₓ^{max}, P_{y}^{max}, P_{z}^{max} are the maximum ball position measurement values measurable through the system.

The inputter 110 receives ball velocity data measured by the measuring device 200. The ball velocity data \hat{V} collected by measuring the velocity of the ball N times through the measuring device 200 is defined as in Equation 6 below.

\hat{V}={\hat{V}₁, . . . ,\hat{V}ᵢ, . . . ,\hat{V}_{N}} [Equation 6]

For example, the unit of velocity of a ball is a unit of velocity in physics (e.g., m/s).

The dimension of each piece of ball velocity data constituting the ball velocity data \hat{V} is three dimensions, and an i^{th} three-dimensional ball velocity vector \hat{V}ᵢ is defined as a normalized measurement value as shown in Equation 7 below.

The processor 130 normalizes the ball velocity data to recognize the virtual ball sports information.

Vᵢ=(V_{x,i}/Vₓ^{max},V_{y,i}/V_{y}^{max},V_{z,i}/V_{z}^{max}) [Equation 7]

V_{x,i}, V_{y,i}, V_{z,i} are actual ball velocity measurement values actually measured in the system, and Vₓ^{max}, V_{y}^{max}, V_{z}^{max} are the maximum ball velocity measurement values measurable through the system.

The inputter 110 receives ball rotation data measured by the measuring device 200. The ball rotation data Ŵ collected by measuring rotations of a ball n times through the measuring device 200 is defined as in Equation 8 below.

Ŵ={Ŵ₁, . . . ,Ŵᵢ, . . . ,W_{N}} [Equation 8]

For example, the unit of rotation of a ball is a unit of velocity in physics (rad/s).

The dimension of each ball rotation vector constituting the ball velocity data Ŵ is three dimensions, and an i^{th} three-dimensional ball rotation vector Ŵᵢ is defined as a normalized measurement value as shown in Equation 9 below.

The processor 130 normalizes the ball rotation data to recognize the virtual ball sports information.

Ŵᵢ=(W_{x,i}/Wₓ^{max},W_{y,i}/W_{y}^{max},W_{z,i}/W_{z}^{max}) [Equation 9]

W_{x,i}, W_{y,i}, W_{z,i} are ball rotation measurement values actually measured in the system, and Wₓ^{max}, W_{y}^{max}, W_{z}^{max} are the maximum ball rotation measurement values measurable through the system.

While the user is using the unified virtual ball sports system, the ball measurement data X collected by N times of measurements through the measuring device 200 mounted within the system is defined as in Equation 10 below.

X={X₁, . . . ,Xᵢ, . . . ,X_{N}} [Equation 10]

The dimension D of each ball measurement vector constituting the ball measurement data X is ten dimensions at the most, and an i^{th} ball measurement vector Xᵢ is defined as in Equation 11 below.

Xᵢ=(x₁, . . . ,x_{d}, . . . ,x_{D})=(\hat{R}ᵢ,\hat{P}ᵢ,\hat{V}ᵢ,Ŵᵢ) [Equation 11]

The ball measurement data X used for DNN learning for automatically recognizing sports events and motions according to the embodiment of the present invention is ten dimensions which are significantly lower than the dimensions of a typical ball image vector used for CNN learning, for example, 10000 dimensions of a ball image vector corresponding to a ball image with 100×100 resolution, so that a small amount of learning data may be constructed.

With respect to ball measurement data X collected by n instances of measurements through the measuring device 200 while the user is using the unified virtual ball sports system, a ball classification label Y in which a sports event and a user motion associated with the ball measurement data X are input in advance is defined as in Equation 12 below.

Y={Y₁, . . . ,Yᵢ, . . . ,Y_{C}} [Equation 12]

The dimension of each label constituting the ball classification label Y is one dimension, and an i^{th} label Yᵢ is defined as in Equation 13 below.

Yᵢ=L(Aᵢ,Bᵢ) [Equation 13]

Yᵢ is a ball classification label corresponding to the i^{th} measured ball measurement data and is determined by a ball classification label function L that has a sports event A, corresponding to the i^{th} measured ball measurement data and a user motion Bᵢ corresponding to the i^{th} measured ball measurement data as parameters.

For example, when the number of sports events desired to be automatically recognized through the ball measurement data training is a, and the number of user motions existing for each sports event is b, the total number of labels C is a×b.

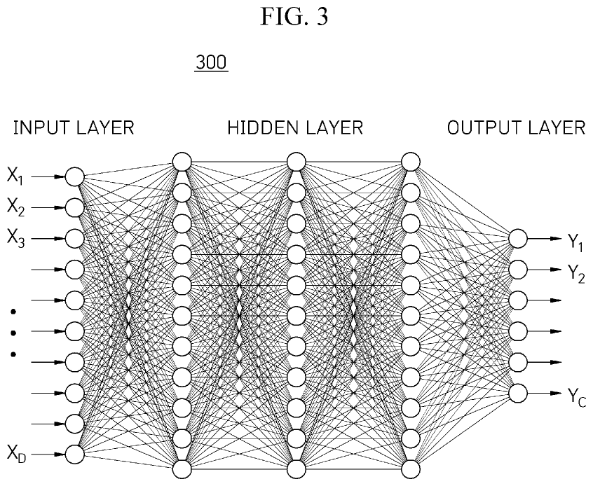

FIG. 3 illustrates a DNN model for automatic recognition of virtual ball sports information according to an embodiment of the present invention.

Referring to FIG. 3, the DNN model includes an input layer for inputting ball measurement data X, an output layer for outputting a ball recognition label Y indicating a sports event and a motion corresponding to the ball measurement data, and hidden layers existing between the input layer and the output layer.

The DNN-based ball measurement data training is for estimating a ball classification label Yᵢ corresponding to input ball measurement data Xᵢ and refers to a process of obtaining a DNN model defined as in Equation 14 below.

Yᵢ=F(Xᵢ) [Equation 14]

The DNN model according to the embodiment of the present invention is obtained by performing ball measurement data training process based on forward propagation or backward propagation-using N pieces of ball measurement data X (ball size data R, ball position data P, ball velocity data V, and ball rotation data W) and a ball classification label Y (a sports event label A and a user motion label B) corresponding to the ball measurement data such that weights and a bias of the interior of the DNN model are calculated to minimize a cost function.

$$\tilde{F} = {min}_{F} \frac{1}{N} C ( {Y}_{i} , F ( {X}_{i} ) ) \qquad [ Equation 15 ]$$

After the above-described DNN learning process, through a DNN model \tilde{F} trained thereby, a ball classification label Yₜ corresponding to a t^{th} ball measurement data Xₜ is estimated by a ball measurement data classification process as shown in Equation 16 below.

\tilde{Y}ₜ=\tilde{F}(Xₜ) [Equation 16]

Through the above-described ball classification label estimating process, a sports event label Aₜ and a user motion label Bₜ corresponding to the ball classification label are automatically recognized as shown in Equation 17 below.

\tilde{Y}ₜ=(Ãₜ,\tilde{B}ₜ) [Equation 17]

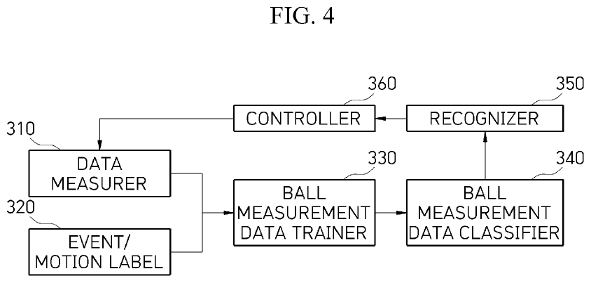

FIG. 4 is a block diagram illustrating a system for automatically recognizing virtual ball sports information according to an embodiment of the present invention.

A data measurer 310 is a measuring device mounted within the system for automatically recognizing virtual ball sports information and measures and collects ball measurement data.

The ball measurement data includes ball size data, ball position data, ball velocity data, and ball rotation data.

A ball measurement data trainer 330 uses the ball size data obtained by normalizing an internal size or a physical size of the ball with a maximum size value for DNN model learning.

The ball measurement data trainer 330 uses the ball position data obtained by normalizing a two-dimensional or three-dimensional position vector of the ball with a maximum position value of each dimension for the DNN model learning.

The ball measurement data trainer 330 uses the ball velocity data obtained by normalizing a three-dimensional velocity vector of the ball with a maximum velocity value of each dimension for the DNN model learning.

The ball measurement data trainer unit 330 uses the ball rotation data obtained by normalizing a three-dimensional rotation vector of the ball with a maximum rotation value of each dimension for the DNN model learning.

The ball measurement data trainer 330 uses an event/motion label 320 corresponding to a sport event label and a user motion label for the DNN model learning.

The DNN model of the ball measurement data trainer 330 may include an input layer for inputting ball measurement data, an output layer for outputting a ball recognition label indicating a sport event and motion associated with the ball measurement data, and hidden layers existing between the input layer and the output layer.

When the DNN learning process of the ball measurement data trainer 330 ends, a ball measurement data classifier 340 estimates a ball classification label corresponding to the ball measurement data through ball measurement data classification.

A recognizer 350 automatically recognizes an event label and a user motion label of a sport that is currently played by the user using the estimation result.

A controller 360 transmits a control command for content using the recognition result.

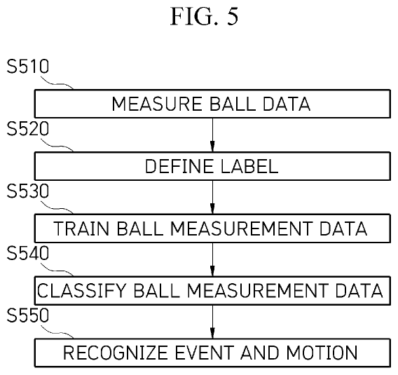

FIG. 5 is a flowchart showing a method of automatically recognizing virtual ball sports information according to an embodiment of the present invention.

The method of automatically recognizing virtual ball sports information according to the embodiment of the present invention includes measuring ball data (S510), defining an event label and a motion label (S520), training ball measurement data (S530), classifying ball measurement data (S540), and recognizing event/motion (S550).

Operation S510 collects data measured from the measuring device mounted within an automatic recognition system for virtual ball sports information.

In operation S510, the ball measurement data including ball size data, ball position data, ball velocity data, and ball rotation data is collected.

Operation S520 defines a ball classification label associated with a sports event and a user motion corresponding to the ball measurement data.

The ball classification label corresponding to the ball measurement data is determined by a ball classification label function that has a sports event and a user motion associated with the ball measurement data as parameters.

Operation S530 is an operation of training ball measurement data and includes: using ball size data obtained by normalizing a system internal unit based size or a physical size of a ball with a maximum size value for DNN model learning; using ball position data obtained by normalizing a two dimensional or three dimensional position vector of a ball with a maximum position value of each dimension for the DNN model learning; using ball velocity data obtained by normalizing a three dimensional velocity vector of a ball with a maximum velocity value of each dimension for the DNN model learning; and using ball rotation data obtained by normalizing a three dimensional rotation vector of a ball with a maximum rotation value of each dimension for the DNN model learning.

In operation S530, an event/motion label corresponding to a sports event label and a user motion label is used for the DNN model learning, and the DNN model includes an input layer for inputting the ball measurement data and an output layer for outputting a ball recognition label indicating a sports event and a motion associated with the ball measurement data, and a hidden layer existing between the input layer and the output layer.

Operation S540, upon termination of the training process of S530, estimates a ball classification label corresponding to the ball measurement data through the ball measurement data classification.

Operation S550 automatically recognizes a sports event label and a user motion label of a sport currently being played by a user using the result estimated in operation S540.

Meanwhile, the automatic recognition method for the virtual ball sports information according to the embodiment of the present invention may be implemented in a computer system or may be recorded on a recording medium. The computer system may include at least one processor, a memory, a user input device, a data communication bus, a user output device, and a storage. The above described components perform data communication through the data communication bus.

The computer system may further include a network interface coupled to a network. The processor may be a central processing unit (CPU) or a semiconductor device for processing instructions stored in the memory and/or storage.

The memory and the storage may include various forms of volatile or nonvolatile media. For example, the memory may include a read only memory (ROM) or a random-access memory (RAM).

Accordingly, the automatic recognition method for the virtual ball sports information according to the embodiment of the present invention may be implemented in the form executable by a computer. When the automatic recognition method for the virtual ball sports information according to the embodiment of the present invention is performed by the computer, instructions readable by the computer may perform the automatic recognition method for the virtual ball sports information according to the embodiment of the present invention

Meanwhile, the automatic recognition method for the virtual ball sports information according to the embodiment of the present invention may be embodied as computer readable codes on a computer-readable recording medium. The computer-readable recording medium is any recording medium that can store data that can be read thereafter by a computer system. Examples of the computer-readable recording medium include a ROM, a RAM, a magnetic tape, a magnetic disk, a flash memory, an optical data storage, and the like. In addition, the computer-readable recording medium may be distributed over network-connected computer systems so that computer readable codes may be stored and executed in a distributed manner.

As is apparent from the above, a flight trajectory and a collision trajectory of the ball are simulated on the basis of ball size, position, velocity, and rotation data measuring a ball that is struck, hit, swung, or thrown by a user, such as in virtual football, virtual baseball, virtual golf, virtual tennis, virtual bowling, and the like, an event and a motion of a ball sport that is currently played by a user can be efficiently and automatically recognized without prior information about an event and a motion of a ball sport currently selected by the user in a unified virtual ball sport system (a unified system that allows various virtual ball sports simulator events to be experienced in one place).

Unlike the conventional technology that requires installation of a user image acquisition camera and performs a time consuming and complicated learning process on a large amount of user image data through a complicated learning module, such as a convolutional neural network (CNN) model, to recognize a ball sports event (soccer, baseball, golf, tennis, bowling, etc.) and detailed motions thereof, the present invention trains a small amount of ball measurement data (ball size, position, velocity, and rotation data) measured through a system while a user is experiencing a virtual ball sport through a unified virtual ball sports system for a short time through a DNN so that an event and a motion of the ball sports that is currently played by the user can be efficiently and automatically recognized and the usability and feasibility can be ensured.

The effects of the present invention are not limited to those mentioned above, and other effects not mentioned above will be clearly understood by those skilled in the art from the above detailed description.

Although the present invention has been described with reference to the embodiments, a person of ordinary skill in the art should appreciate that various modifications, equivalents, and other embodiments are possible without departing from the scope and sprit of the present invention. Therefore, the embodiments disclosed above should be construed as being illustrative rather than limiting the present invention. The scope of the present invention is not defined by the above embodiments but by the appended claims of the present invention, and the present invention is to cover all modifications, equivalents, and alternatives falling within the spirit and scope of the present invention.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A server for automatically recognizing virtual ball sports information, the server comprising:
an inputter configured to receive ball measurement data;
a memory in which a program for automatically recognizing virtual ball sports information is stored; and
a processor configured to execute the program,
wherein the processor automatically recognizes information about a virtual ball sport that is currently played by a user using the ball measurement data and a ball classification label.

2. The server of claim 1, wherein the inputter receives the ball measurement data including at least one of size data, position data, velocity data, and rotation data of a ball measured by a measuring device mounted inside a unified virtual ball sports system.

3. The server of claim 2, wherein the processor performs normalization on the ball measurement data in consideration of a maximum value of the ball measurement data and uses the normalized data for deep neural network (DNN) model learning.

4. The server of claim 3, wherein the processor performs automatic recognition on the virtual ball sports information including a sports event and a motion on the basis of the DNN model learning.

5. The server of claim 1, wherein the processor uses the ball classification label in which a sports event and a user motion corresponding to the collected ball measurement data have been input in advance for the DNN model learning.

6. The server of claim 5, wherein the processor, through a ball measurement data training process using the ball measurement data and the ball classification label corresponding to the ball measurement data, calculates a weight and a bias of an interior of the DNN model such that a cost function is minimized to perform the DNN model learning.

7. A system for automatically recognizing virtual ball sports information, the system comprising:
a data measurer configured to measure and collect ball measurement data;
a ball measurement data trainer configured to perform learning using deep neural network (DNN) model learning which uses the ball measurement data and a label regarding a virtual ball sport; and
a ball measurement data classifier configured to calculate virtual ball sports information corresponding to the ball measurement data according to a result of the DNN model learning.

8. The system of claim 7, wherein the data measurer is mounted within a unified virtual ball sports system.

9. The system of claim 7, wherein the DNN model includes an input layer for inputting the ball measurement data and an output layer for outputting a label indicating a sports event and a motion associated with the ball measurement data.

10. The system of claim 7, wherein the ball measurement data trainer uses the DNN model learning which uses ball size data obtained by normalizing a system internal unit-based size or a physical size of a ball with a maximum size value.

11. The system of claim 7, wherein the ball measurement data trainer uses the DNN model learning which uses ball position data obtained by normalizing a position vector of a ball with a maximum position value of each dimension.

12. The system of claim 7, wherein the ball measurement data trainer uses the DNN model learning which uses ball velocity data obtained by normalizing a velocity vector of a ball with a maximum velocity value of each dimension.

13. The system of claim 7, wherein the ball measurement data trainer uses the DNN model learning which uses ball rotation data obtained by normalizing a rotation vector of a ball with a maximum rotation value of each dimension.

14. A method of automatically recognizing virtual ball sports information, the method comprising the steps of:
(a) receiving ball measurement data acquired from a measuring device mounted within a unified virtual ball sports system;
(b) defining a label associated with an event and a user motion as virtual ball sports information;
(c) performing ball measurement data-based learning using the ball measurement data and the label;
(d) estimating a ball classification label corresponding to the ball measurement data; and
(e) automatically recognizing an event and a user motion of a sport that is currently played by a user in the unified virtual ball sports system.

15. The method of claim 14, wherein step (a) includes receiving the ball measurement data including ball size data, ball position data, ball velocity data and ball rotation data.

16. The method of claim 14, wherein step (b) includes defining a ball classification label corresponding to measurement data that is measured and collected by the measuring device.

17. The method of claim 14, wherein step (c) includes performing normalization on the ball measurement data in consideration of a maximum value of the ball measurement data measurable by the measuring device and using the normalized data for deep neural network (DNN) model learning.

18. The method of claim 17, wherein step (c) includes: using the DNN model learning which uses ball size data obtained by normalizing a system internal unit based size or a physical size of a ball with a maximum size value; using the DNN model learning which uses ball position data obtained by normalizing a position vector of the ball with a maximum position value of each dimension; using the DNN model learning which uses ball velocity data obtained by normalizing a velocity vector of the ball with a maximum velocity value of each dimension; and using the DNN model learning which uses ball rotation data obtained by normalizing a rotation vector of the ball with a maximum rotation value of each dimension.
